(19) United States
(12) Patent Application Publication
(10) Pub. No.: US 2022/0108208 A1
(43) Pub. Date: Apr. 7, 2022

(54) SYSTEMS AND METHODS PROVIDING CONTEXTUAL EXPLANATIONS FOR DOCUMENT UNDERSTANDING

(71) Applicant: INTUIT INC., Mountain View, CA (US)

(72) Inventors: Tak Yiu Daniel LI, Plano, TX (US); Priyadarshini RAJENDRAN, Plano, TX (US); Deepankar MOHAPATRA, Plano, TX (US); Sungjae KIM, Plano, TX (US)

(73) Assignee: INTUIT INC., Mountain View, CA (US)

(21) Appl. No.: 17/062,250

(22) Filed: Oct. 2, 2020

(51) Int. Cl. G06N 20/00; G06N 5/04

(52) U.S. Cl. CPC G06N 20/00; G06N 5/04

(57) ABSTRACT

Systems and methods for providing contextual information for computerized document understanding. The systems and methods can be used to assist users in filling out documents by providing contextual information based on anomalies identified in a provided document. The methods and systems may identify the deficiency in the document and automatically generate a query related to the anomaly. The query can be fed as an input to a question-answering (QA) model that can provide an answer as the contextual information.

### BACKGROUND OF THE DISCLOSURE

Computerized document understanding typically includes computer vision, optical character recognition, and/or other processing techniques to comprehend the contents of documents without human intervention. Understanding or comprehending a document can include anything from the classification of the document type to the identification, extraction, and/or storage of relevant values or information from the document. In some fields, such as accounting, tax, and other fields that can be document-intensive, document comprehension can also include the presentation of relevant information to various applications in a structured way. For example, when a user utilizes accounting software to analyze his/her financials or utilizes tax software to prepare a tax return, it is common for the user to upload, via the internet, various types of documents for processing such as e.g., W-2's, 1099's, invoices, etc.

However, when going through the initial process of filling out documents (either online forms or a physical document), the user may have questions about a particular field or box. For example, for tax preparation, the user may be confused on what is considered to be his or her dependent. In other examples, the user may be confused by what a withholding is, or may not understand other terms and/or how to perform certain calculations. To get help, the user may contact customer service (e.g., by calling a customer service line or connecting with an online representative via chat) to ask questions related to his/her document. This can create various issues such as e.g., overloading the customer service centers. More significantly, the customer representative may not be knowledgeable enough to answer the user's question and may be forced to provide generic or unspecific answers, such as directing the user to an online search tool, instruction manual, or reference page. This can be potentially frustrating, tedious, and time-consuming for a user having trouble filling out and trying to upload a document.

Similarly, if the user is confused or is having trouble filling out a particular field or putting forth certain information in a document, he/she may decide to simply leave the field blank and upload the incomplete document for processing. While document processing platforms may be able to detect an error, the information provided by the platform may not be the most helpful for the user. In some cases, the only information provided may be an identification of the blank field (e.g., “SSN is blank”). In other cases, the information provided by the platform, if any, may not be any more informative than what the user would have obtained from a customer service representative, search engine or reference manual. In yet other cases, a long and potentially complex and/or tedious list of steps may be provided to the user. Each of these situations are undesirable.

An example of the type of information displayed to the user that may not be preferred or the most efficient methodology of answering the user's question is shown in FIG. 1, which is an example user interface 100 output by currently existing question-answering (QA) systems used answer user questions. In the illustrated example, the user typed the question, “when is w-2 due?” into a search bar 101 within the user interface 100. The associated QA system may analyze the question and provide a list 102 of “answers.” However, this list 102 may not include the exact, precise, or ideal answers to the user's question. Instead, as shown in the example, the system outputs a list of links and resources that the user can explore further to find its answer. In many cases, filling out financial documents can be a stressful situation, and many users may not wish to spend unnecessary time and focus sifting through various links to get help filling out a document. Moreover, the current QA technique may cause the user to leave the document preparation session when one of the provided links are selected. This is also undesirable.

### BRIEF DESCRIPTION OF THE FIGURES

FIG. 1 is an example user interface output by currently existing question-answering (QA) systems.

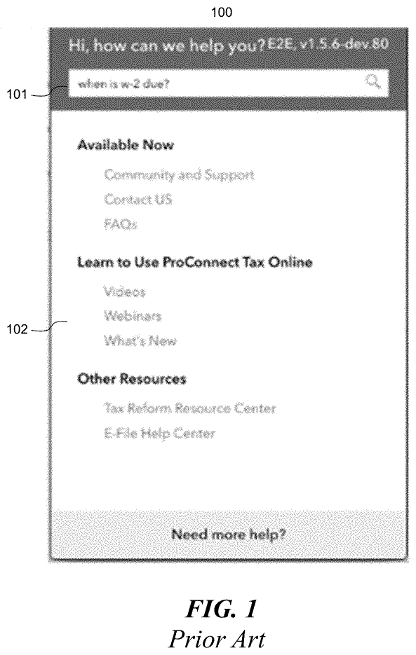

FIG. 2 is a block diagram of an example system for providing contextual explanations for document understanding according to some embodiments of the present disclosure.

FIG. 3 is a flow diagram showing example processing that may occur to provide contextual information based on a received document according to some embodiments of the present disclosure.

FIG. 4 is a flow diagram showing example processing that may occur to determine an anomaly in a document, according to some embodiments of the present disclosure.

FIG. 5 is an example system flow diagram for providing contextual explanations for document understanding according to some embodiments of the present disclosure.

FIG. 6 illustrates inputs and outputs for obtaining a contextual explanation according to some embodiments of the present disclosure.

FIG. 7 is a flow diagram showing example processing that may occur to provide contextual information based on a user query according to some embodiments of the present disclosure.

FIG. 8 is a system flow diagram for providing contextual information based on a user query according to some embodiments of the present disclosure.

FIG. 9 is an example server device that may be used within the system of FIG. 2 according to an embodiment of the present disclosure.

FIG. 10 is an example computing device that may be used within the system of FIG. 2 according to an embodiment of the present disclosure.

### DETAILED DESCRIPTION OF SEVERAL EMBODIMENTS

Embodiments of the present disclosure relate to various systems and methods for providing contextual information for document understanding. The disclosed principles can be used to assist users in filling out documents by providing contextual information based on the deficiencies (or anomalies) identified in an uploaded document.

For example, a user may upload to a tax service a W-2 form missing its social security number (SSN). Without the disclosed principles, this would cause an error and force the user to receive help in the undesirable manners mentioned above. However, according to the disclosed principles, the disclosed methods and systems may identify the deficiency in the document and automatically generate a question related to the anomaly (herein referred to as a “query”). The query can be fed as an input to a trained question-answering (QA) model that may be specifically finetuned with keywords and or other jargon related to the application (e.g., tax, accounting, and or other financial services). The QA model can provide an answer (herein referred to as contextual information or contextual explanations), which can be forwarded for display on a device associated with the user. The contextual information may include various information such as the required format for the missing information and or a specific action that should be taken to correct the error, although the contextual information may vary according to the anomaly and underlying service (i.e., accounting, taxes, financial management, etc.). It should be appreciated that, while the embodiments described herein are described as being utilized with accounting, tax, and or financial documents, the disclosed principles are not so limited and may apply to any form-based document and its related service.

In some embodiments, the disclosed principles may perform various analyses to determine whether identified document deficiencies are indeed anomalies. For example, many tax or financial documents commonly contain blank spaces or blank fields, but are still considered complete. A blank field does not necessarily correlate to an anomaly in those documents and thus does not necessarily correlate to something a user should receive contextual information for. For example, a majority of users may leave a certain field blank in a certain document, which suggests that a value may not be necessary to complete the document and that it would be a waste of time and processing resources to provide an unwanted piece of information to the user. Accordingly, the disclosed principles may analyze a history of similar documents prior to providing contextual information to determine if the contextual information would be valued by the user.

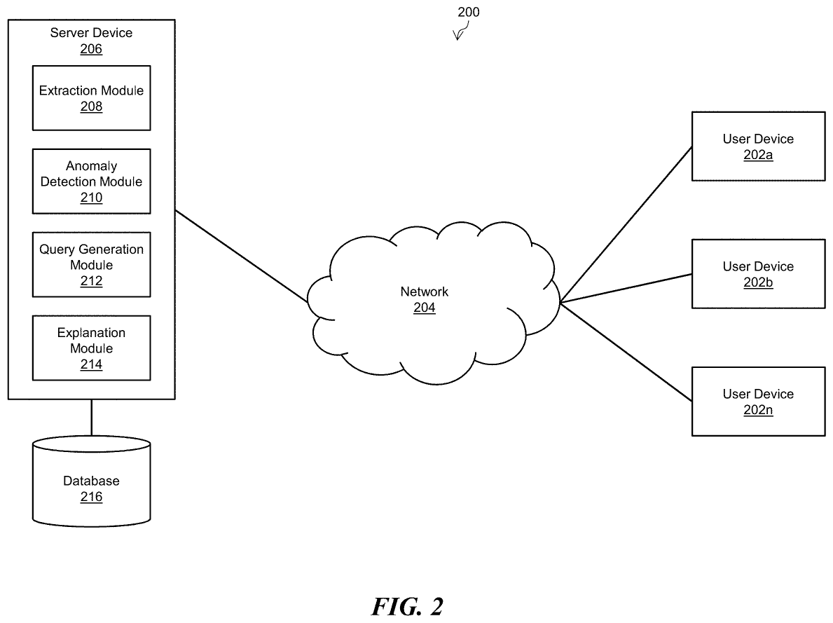

FIG. 2 is a block diagram of an example system 200 for providing contextual explanations for document understanding according to some embodiments of the present disclosure. System 200 can include a plurality of user devices 202a-n (generally referred to herein as “user device 202” or collectively referred to herein as “user devices 202”) and a server device 206, which can be communicably coupled via network 204. In some embodiments, system 200 can include any number of user devices 202. For example, for an organization that manages accounting software or tax software and an associated database or databases, there may be an extensive user base with thousands or even millions of users that may connect via applications or web browsers from respective user devices 202.

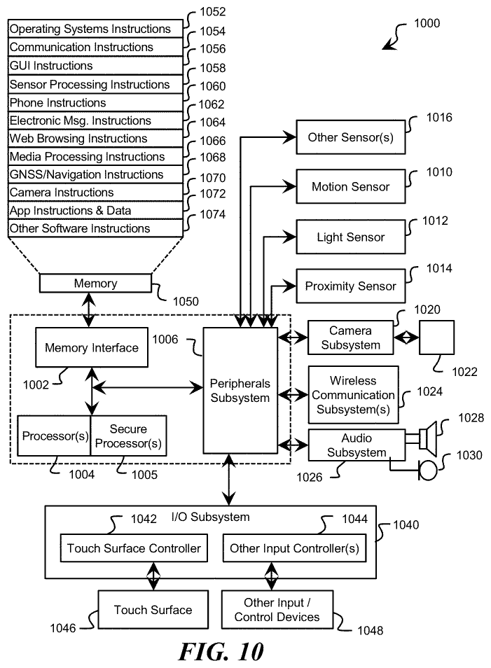

A user device 202 can include one or more computing devices capable of receiving user input as well as transmitting and/or receiving data via network 204 or communicating with server device 206. In some embodiments, a user device 202 can include a conventional computer system, such as a desktop or laptop computer. Alternatively, a user device 202 may include a device having computer functionality, such as a personal digital assistant (PDA), a mobile telephone, a smartphone, or other suitable device. In some embodiments, a user device 202 may be the same as or similar to user device 1000 described below with respect to FIG. 10.

Network 204 may include one or more wide areas networks (WANs), metropolitan area networks (MANs), local area networks (LANs), personal area networks (PANs), or any combination of these networks. Network 204 may include a combination of one or more types of networks, such as Internet, intranet, Ethernet, twisted-pair, coaxial cable, fiber optic, cellular, satellite, IEEE 801.11, terrestrial, and/or other types of wired or wireless networks. Network 204 can also use standard communication technologies and/or protocols.

As shown in FIG. 2, server device 206 can include an extraction module 208, anomaly detection module 210, a query generation module 212, and an explanation module 214 and can be communicably connected to a database 216. Server device 206 can be configured to receive documents (e.g., electronic versions of documents or images of documents) from a user device 202 over the network 204. In some embodiments, a user device 202 can upload a document to the server device 206 via an application, web application, or directly through a web browser. The document can be received in a variety of formats, such as a PDF, DOCX, etc. In addition, the document can be received as an image of a physical document in a format such as JPEG, PNG, TIF, etc. In some embodiments, the server device 206 can be configured to receive a query directly from a user device 202. Server device 206 can access the database 216, which may include historical documents related to particular applications, such e.g., as tax, accounting and or financial management applications. For example, if server device 206 was running tax filing software, the database 216 may contain tax-related documents submitted for users' tax filings from previous years. In some embodiments, the documents may be stored anonymously and used for analytical purposes related to methods described herein. Once a document is received by the server device 206, modules 208-214 may process the document and perform various tasks in accordance with the disclosed principles to provide contextual information back to the user device 202 and displayed on the user device 202.

In one or more embodiments, the extraction module 208 may be configured to analyze a document or an image of a document received from a user device 202. For example, the extraction module 208 may perform image processing such as OCR in accordance with pre-defined models for extracting text from specific document types, as well as any other text extraction technique known in the art. The extraction module 208 may be configured to extract financial data written onto a tax form (e.g., handwritten or typed by a user) and use it to fill out and complete a tax return. In some embodiments, the extraction module 208 can be configured to detect the document type received, identify fields related to “boxes” or “spaces” that can be filled out on a form, and detect empty spaces. In some embodiments, the extraction module 208 can also be configured to extract values from fields within the document, such as income, number of dependents, or other such values. In one or more embodiments, the extraction module 208 provides an extracted output based on the above principles.

The anomaly detection module 210 can be configured to detect anomalies in a document received from the user device 202, such as e.g., the extracted output of the extraction module 208. In some embodiments, the anomaly detection module 210 may be configured to receive the identified document type and identified field related to a detected empty space from the extraction module 208. The anomaly detection module 210 may be configured to detect various types of anomalies in the document from the extracted output. In some embodiments, the detection of an anomaly in a document can include identifying an insufficiency in the document and then analyzing the insufficiency to determine if it should be classified as an anomaly. For example, insufficiencies can include blank spaces or blank fields and the anomaly detection module 210 may be configured to determine whether the insufficiency is anomaly by analyzing similar documents (e.g., documents stored in database 216) for statistics on that particular field. If a particular field is commonly left blank, then the insufficiency may not be determined to be an anomaly by the anomaly detection module 210. However, if a particular field is rarely left blank by other users, the empty space may be determined to be an anomaly by the anomaly detection module 210.

In some embodiments, an anomaly may be detected based on the actual values extracted from the document by the extraction module 208. That is, the disclosed principles are not limited to finding anomalies based on blank fields and may instead detect anomalies based on incorrect entered values or content. For example, the anomaly detection module 210 may determine that the wages entered by a user are less than the tax amount, which would be considered abnormal and thus an anomaly. It should be appreciated that these are merely examples and that the anomaly detection module 210 may include a list of rules to apply to each document or the extracted output of the document to determine if there are various types of anomalies.

The query generation module 212 can be configured to generate queries (e.g., questions) based on the anomalies detected by the anomaly detection module 210. In some embodiments, the query generation module 212 can be configured to compile text to form a phrase or question. It should be appreciated that the query is not required to be in the form of a question. Generating the query can include compiling text associated with the field in which the anomaly has been detected and associated with the document type. For example, if a document is missing a social security number, the query can be “What is a social security number and where do I find it?” In another example, if a document has a tax bill generated that is higher than the wages provided as being earned, the query can be “what do I do if my taxes owed are incorrect?” In addition, the user could ask questions such as “why are my taxes more than last year?”

The explanation module 214 can include a trained QA model and can be configured to receive a textual query from the query generation module 212 and feed the query into the QA model. In some embodiments, the QA model can include a bidirectional encoder representation from transformers (BERT) model. As is known in the art, a BERT model is a language processing model and can include various transformer encoder blocks that are trained to understand contextual relations between words. A BERT model can analyze text bidirectionally instead of left to right or right to left. A standard BERT model can include two mechanisms in its transformer: an encoder that can read input text and a decoder that predicts text to follow the input text. A BERT model may operate on and process word or text vectors (e.g., text that has been embedded to a vector space). A neural network with layers (e.g., various transformer blocks, self-attention heads) then analyzes the word vectors for prediction or classification.

In some embodiments, the BERT model may be converted to a QA model (e.g., where the BERT model predicts an answer for the input text that is in the form of a question) and fine-tuned with various tax-related and/or finance-related keywords and may be trained to identify relevant answers within specifically defined areas of text. For example, the BERT model may be fine-tuned with instructions and references from the Internal Revenue Service (IRS), internal documents of an organization that are related to FAQs and other helpful-type resources that a user would normally have to sift through themselves, online tax or finance related publications, and tax documents. After receiving a question from the query generation module 212, the fine-tuned BERT model can receive an embedded question (e.g., in vector format or a query vector) and predict an answer from within a pre-defined sequence or passage of text or a body of text. As described herein, the pre-defined sequence or passage of text can include the IRS instructions and references, other tax documents, FAQs and other resources related to taxes and finance, and online tax or finance related publications. In some embodiments, fine-tuning the BERT model for tax or finance specific purposes can include altering parameters in the self-attention head mechanisms. The BERT model can be trained using annotated examples of various question answering situations pertaining to the tax and accounting domain, while fine tuning can be done on tax and accounting taxonomy including pre/post processing and annotation. For example, the explanation module 214 can receive a query from query generation module 212, embed the query to a vector format (herein referred to as a query vector), and feed the query vector to the fine-tuned BERT model. The BERT model can predict an answer from the pre-trained references and output the answer, which can herein be referred to as contextual information or a contextual explanation. The explanation module 214 can then be configured to cause this output to be displayed on a user device 202.

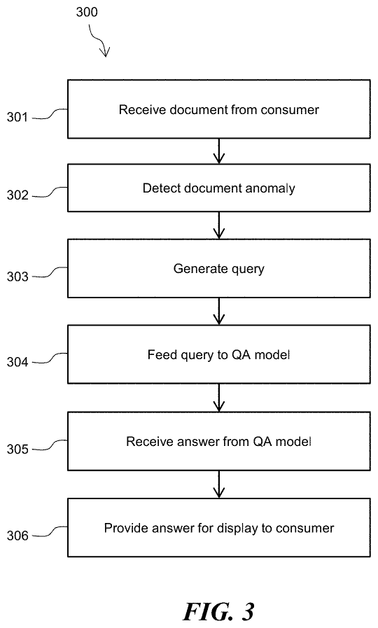

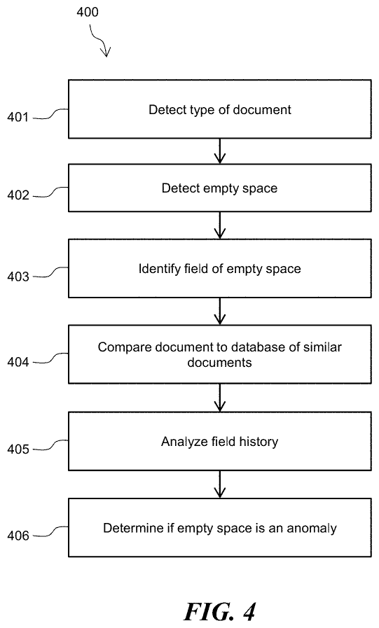

FIG. 3 is a flow diagram showing an example process 300 that may be used to provide contextual information based on a received document, according to some embodiments of the present disclosure. In some embodiments, the process 300 may be performed by the server device 206 of system 200 and various modules within the server device 206. At block 301, the server device 206 can receive a document from a user (via e.g., user device 202). This can include receiving an electronic document (e.g., a PDF or Word document) or an image of a physical document from a user device 202 associated. For example, a user may submit, via a tax filing or accounting software interface on its user device 202, the image of the document. The document may be sent over the network 204 and received by the server device 206, where it can be stored in database 216 and analyzed by the various modules disclosed herein. For example, at block 302, the anomaly detection module 210 may detect document anomalies within the document received from the user. In some embodiments, prior to detecting any anomalies, the extraction module 208 can process the image of the document to: extract various types of information from the document, such as e.g., the document type (e.g., W-2, 1099, etc.), identify various fields within the document and their respective values (e.g. the income field and a written income of $60,000), and identify any empty spaces of particular fields (e.g., the SSN field was left blank or the number of dependents field was left blank). In order to detect anomalies, the anomaly detection module 210 may analyze the extracted information from the extraction module 208 (described in more detail with respect to FIG. 4).

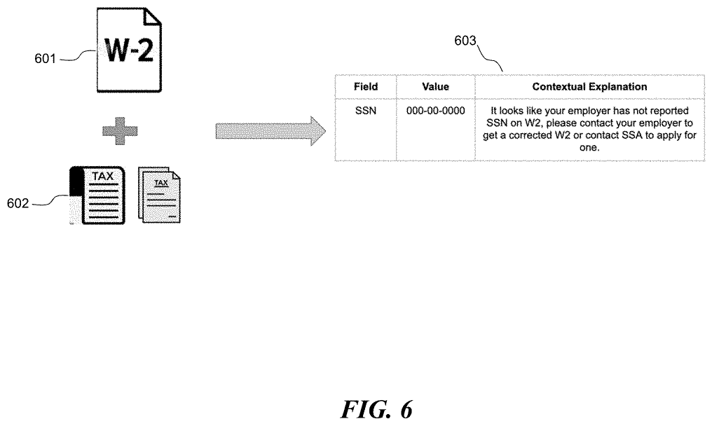

At block 303, in response to an anomaly being detected in the received document, the query generation module 212 can generate a query based on the detected anomaly. For example, generating a query may include compiling a textual phrase or question based on the anomaly (e.g., the query may be based on the field associated with the anomaly). At block 304, the explanation module 214 can feed the query to a QA model (e.g., a fine-tuned BERT model as described in relation to FIG. 2). In some embodiments, feeding the query to a QA model can include embedding the query, which can be in textual format, to a vector format in a vector space (e.g., a query vector). In some embodiments, this can be done via an encoder that is part of the QA model. The encoder can be fine-tuned with tax-related and or finance-related jargon and keywords to enhance the performance of the encoder's embedding process. The explanation module 214 can use the QA model to identify contextual information associated with the query within a pre-defined set of text. As described in relation to FIG. 2, the pre-defined set of text can include custom-chosen documents, references, and manuals from the IRS and other related publications. The identified contextual information associated with the query can be one or more identified spans or segments of text within the pre-defined set. For example, the QA model can identify a phrase within a long passage of text that best answers the query (discussed below in more detail with reference to FIG. 6).

At block 305, the explanation module 214 can receive an answer (herein referred to as contextual information or a contextual explanation) from the QA model. The contextual information can be the identified span of text from block 304. In some embodiments, the identified span of text can be de-embedded from the vector format into a textual format. At block 306, the contextual information can be sent to and displayed on the user device 202 associated with the user. As can be appreciated, the contextual information may help the user fix or correct any anomalies or other issues in its submitted document.

FIG. 4 is a flow diagram showing an example process 400 that may be used to determine an anomaly in a document according to some embodiments of the present disclosure. In some embodiments, process 400 can be performed within block 302 of process 300 (FIG. 3) and can be performed by server device 206 using a document received from a user device 202. At block 401, the extraction module 208 can identify the document's document type (e.g., W-2, 1099-INT, 1099-MISC, invoice, etc.). For example, the extraction module 208 can use standard OCR techniques and other image processing and or text processing techniques to determine the document type. In some embodiments, the document type can be identified by detecting an indicator provided by the user, such as when the user indicates that he or she is submitting a W-2 form or other document type. At block 402, either the anomaly detection module 210 or extraction module 208 can detect an empty space in the received document. In some embodiments, detecting an empty space can include utilizing various OCR techniques to identify “boxes” or “fields” based on contrasts between white and black, and then analyzing the inside area of the identified box or field. In some embodiments, pre-defined models can be utilized that are associated with the document type. For example, an image analysis model designed for W-2's may be used to detect each field or box in the document. If there is nothing identified within the box or field, then the process 400 can determine that it is an empty space. At block 403, in response to detecting an empty space, the extraction module 208 may identify the field “label” associated with the empty space. In some embodiments, this can be performed by extracting text from a region adjacent to or near the empty space.

At block 404, the anomaly detection module 210 can compare the document to a database (e.g., database 216 of FIG. 2) of similar documents. At block 405, anomaly detection module 210 can analyze the field history. For example, anomaly detection module 210 can access historical documents stored in database 216 and perform various statistical techniques to determine if an empty space (e.g., as identified by extraction module 208) should be considered an anomaly. In some embodiments, the documents can be of the same type and can be referred to herein as a historical same-type document. In some embodiments, anomaly detection module 210 can analyze only historical documents that are the same type as the type of the received document to determine if the empty space is an anomaly, such as analyzing a plurality of historical W-2's to analyze a received W-2 from a user. Anomaly detection module 210 can be configured to calculate a percentage of historical documents that have left the relevant field blank, and if the percentage is below a certain, pre-defined threshold, then the empty space can be determined to be an anomaly. In other words, if it is historically rare for a field to be left blank in a certain document type, then it can be considered an anomaly since it was left blank in the received document. On the other hand side, if it is historically common for a field to be left blank in a certain document type, it may not be abnormal for a user to leave it black and thus it may not be an anomaly requiring contextual information to be generated and provided based on the blank field. In some embodiments, the pre-defined threshold can refer to a pure number of historical documents that have left the field blank, rather than a percentage. In some embodiments, the pre-defined threshold can vary by document, document type and even by field. At block 406, based on the analysis of the database of documents and field history, the anomaly detection module 210 can determine if the empty space is an anomaly or not.

In one or more embodiments, the anomaly detection module 210 can analyze values extracted by extraction module 208 to determine anomalies (i.e., one or more anomalies can be detected for non-blank spaces). For example, an income value may be analyzed and compared to a determined amount of tax owed for the user. If the income value provided in the received document is greater than the amount of tax owed, anomaly detection module 210 can determine that this is an anomaly. In some embodiments, another example of an anomaly can be in a 1099-INT form. If the total interest does not match the addition of itemized values, an anomaly can be flagged. In yet another example, if on a W2 box 12, the code is not a valid code, an anomaly can also be flagged. For example, ZZ is not a valid code according to IRS instructions.

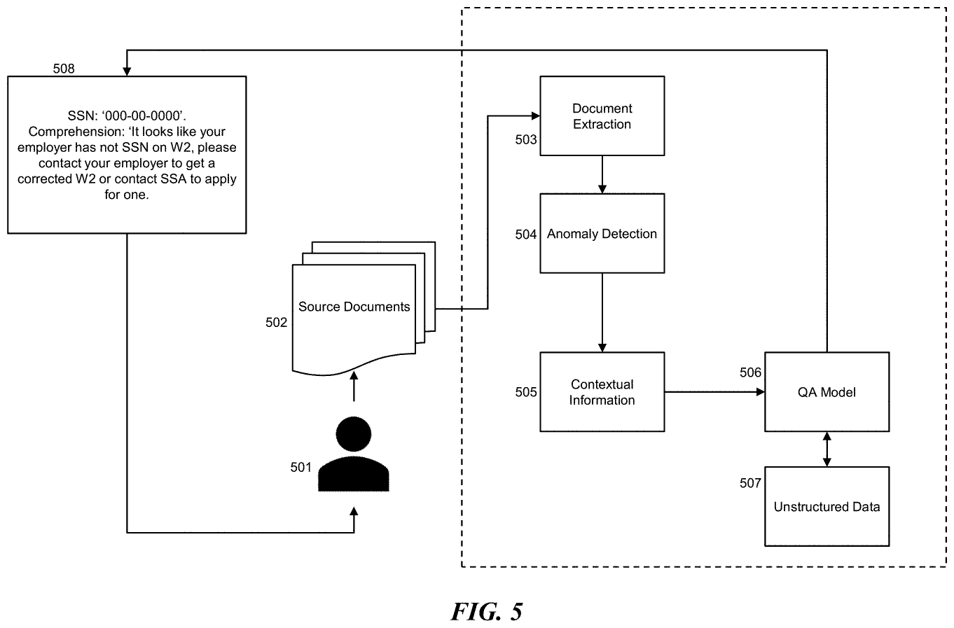

FIG. 5 is a system flow diagram for providing contextual information according to some embodiments of the present disclosure. At 501, a user can log on to or access an online tax-filing or accounting software via a device such as a computer (e.g., user device 202 in FIG. 2). At 502, the user can upload one or more documents, such as documents that can be used for preparing a tax return or managing accounting tasks. It should be noted that the dotted lines within FIG. 5 are used to delineate what a user experiences versus the processing performed by a server (such as server 206 of FIG. 2). At 503, document extraction can be performed on the document, such as by extraction module 208 as described above with reference to FIGS. 2 and 3. At 504, anomaly detection can be performed on the extracted information and the document, such as by anomaly detection module 210 as described above with reference to FIGS. 2 through 4. At 505, contextual information can be generated by generating a query associated with the detected anomaly in 504 via e.g., the query generation module 212. The generated query can be sent to a QA model. At 506, the QA model can be configured to identify passages from unstructured data (input from block 507) that are relevant to the query, such as in an “answer” format. The unstructured data can include various tax documents, IRS references and manuals, and other publications depending upon the underlying service being used, such as those described in relation to FIGS. 2-3, which may be used to fine-tune the QA model.

In some embodiments, the data and/or passage/body of text that the QA model searches and parses for relevant passages can be embedded to a vector format (e.g., a body vector); the query can also be embedded to a vector format and relevant passages can be identified in the vector space. As used herein, unstructured data can refer to data that does not have a pre-defined model or is not organized in a pre-defined manner. The identified passage in the unstructured data can be de-embedded from vector format back to a text format if desired. At 508, the contextual information (e.g., the “answer”) can be provided for display to the user in the software they operated to submit the original document. For example, as shown in FIG. 5, assuming the user submitted a document in which the social security number was missing, the contextual information identified by the QA model within the unstructured data can include a format of the missing data: “SSN: ‘000-00-0000’”. The contextual information can also include a textual phrase that directs the user how to proceed: “It looks like your employer has not provided an SSN on W2, please contact your employer to get a corrected W2 or contact SSA to apply for one.” Rather than having to go through a customer service representative or search through tedious references and instructional resources online, the user can receive specific instructions and contextual information relevant to the missing information in his/her document.

FIG. 6 illustrates inputs and outputs for obtaining a contextual explanation according to some embodiments of the present disclosure. In FIG. 6, to further illustrate the example as used in FIG. 5, the user has submitted a W-2 form 601. A fine-tuned QA model can process the W-2 form 601 according to the methods described herein and compare it to a plurality of historical documents of the same type. As discussed herein, relevant passages are identified using an unstructured set of tax data 602. Block 603 illustrate an example output displayed to the user, where the field (“SSN”), the format of the value (“000-00-0000”), and an explanation (“It looks like your employer has not provided an SSN on W2, please contact your employer to get a corrected W2 or contact SSA to apply for one.”) are displayed to the user in accordance with the disclosed principles.

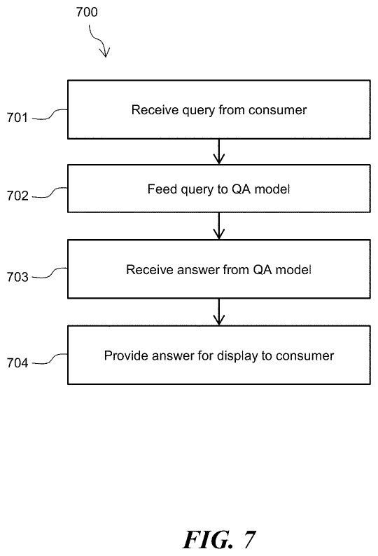

FIG. 7 is a flow diagram showing an example process 700 that may be used to provide contextual information based on a query, according to some embodiments of the present disclosure. In these embodiments, the fine-tuned QA model can be applied in other, more direct ways. For example, in some embodiments, the QA model can be accessed by users directly, as opposed to being used for processing of incomplete documents. Process 700 can be performed by the server device 206 and, in particular, the explanation module 214. At block 701, the explanation module 214 can receive a query from a user device 202. This can be similar to receiving a query from the query generation module 212, as described in FIGS. 2-4, except the query can originate directly from the user. For example, in a tax-filing or accounting software, a user may directly access a search bar or tool in which he/she can type a query and it can be sent to explanation module 214. At block 702, the query can be fed to a QA model. In some embodiments, the query that the user entered can be embedded to a vector format for analysis by the QA model. The QA model, similar to or the same as described in relation to block 304 of FIG. 3, can predict a relevant passage of text from a pre-defined passage of text (e.g., IRS publications, tax documents, and other resources) based on the embedded query. The “prediction” can occur within the vector space of the embedded query and embedded text. Once a relevant span of text is chosen, the span can be de-embedded back to a textual format. At block 703, the answer can be received from the QA model and, at block 704, it can be provided for display to the consumer on the associated user device 202.

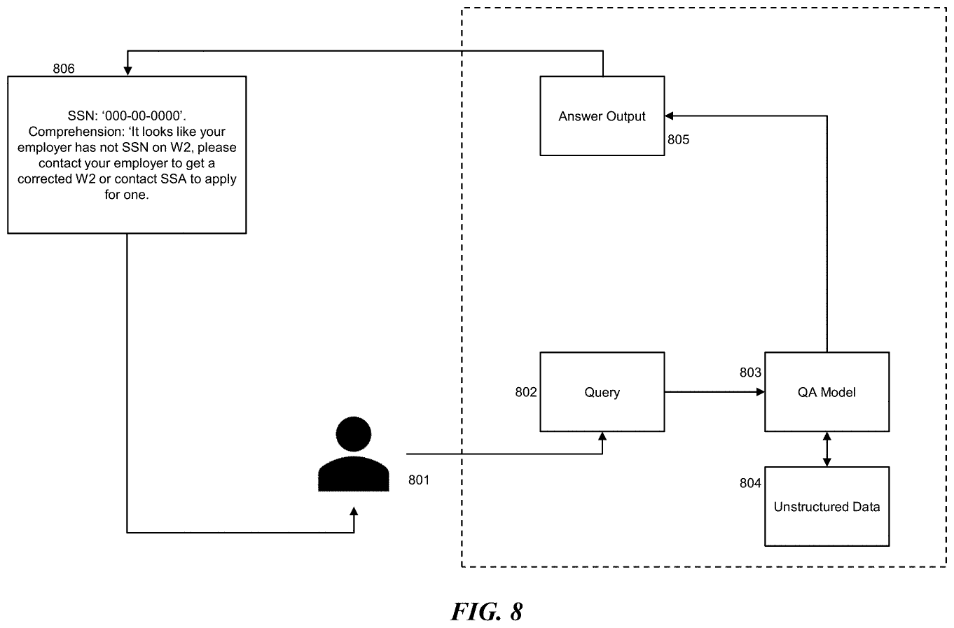

FIG. 8 is a system flow diagram for providing contextual information based on a query according to some embodiments of the present disclosure. At 801, a user can log on to or access online tax-filing or accounting software via a device such as a computer (e.g., device 202 in FIG. 2). At 802, the user can manually type (e.g., via a keyboard or touchscreen on user device 202) a query directly into a search bar or similar user interface on a web browser or within a software application. For example, the user can search “How do I calculate my income,” “What is a social security number,” or “why is my social security number missing from my W-2?” At 803, the query can be sent to a QA model. The QA model can be configured to identify passages from unstructured data (input at 804) that are relevant to the query, such as in an “answer” format. The unstructured data can include various tax documents, IRS references and manuals, and other publications, such as those described in relation to FIGS. 2-3, which are used to fine-tune the QA model. In some embodiments, the data that the QA model searches and parses for relevant passages can be embedded to a vector format; the query can also be embedded to a vector format and relevant passages can be identified in the vector space. The identified passage in the unstructured data can be de-embedded from vector format back to a text format. At 805, the contextual information (e.g., the “answer”) can be provided for display to the user in the software or browser used to input the original query. For example, as shown at 806, assuming the user submitted a query asking about the meaning of a social security number, the contextual information identified by the QA model within the unstructured data can include a format of the missing data: “SSN: ‘000-00-0000’”. The contextual information can also include a textual phrase that directs the user how to proceed: “It looks like your employer has not provided an SSN on W2, please contact your employer to get a corrected W2 or contact SSA to apply for one.” Rather than having to go through a customer service representative or search through tedious references and instructional resources online, the user can receive specific instructions and contextual information relevant to the missing information in his/her document.

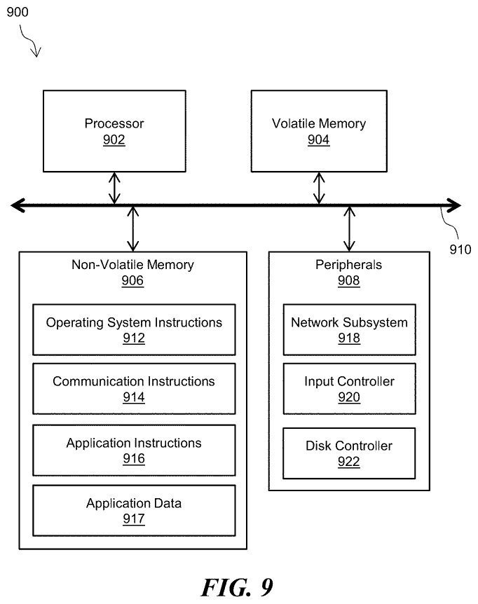

FIG. 9 is a diagram of an example server device 900 that may be used within system 200 of FIG. 2. Server device 900 may implement various features and processes as described herein. Server device 900 may be implemented on any electronic device that runs software applications derived from complied instructions, including without limitation personal computers, servers, smart phones, media players, electronic tablets, game consoles, email devices, etc. In some implementations, server device 900 may include one or more processors 902, volatile memory 904, non-volatile memory 906, and one or more peripherals 908. These components may be interconnected by one or more computer buses 910.

Processor(s) 902 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 910 may be any known internal or external bus technology, including but not limited to ISA, EISA, PCI, PCI Express, USB, Serial ATA, or FireWire. Volatile memory 904 may include, for example, SDRAM. Processor 902 may receive instructions and data from a read-only memory or a random access memory or both. Essential elements of a computer may include a processor for executing instructions and one or more memories for storing instructions and data.

Non-volatile memory 906 may include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 906 may store various computer instructions including operating system instructions 912, communication instructions 914, application instructions 916, and application data 917. Operating system instructions 912 may include instructions for implementing an operating system (e.g., Mac OS®, Windows®, or Linux). The operating system may be multi-user, multiprocessing, multitasking, multithreading, real-time, and the like. Communication instructions 914 may include network communications instructions, for example, software for implementing communication protocols, such as TCP/IP, HTTP, Ethernet, telephony, etc. Application instructions 916 may include instructions for providing contextual information in conjunction with document understanding according to the systems and methods disclosed herein. For example, application instructions 916 may include instructions for components 208-214 described above in conjunction with FIG. 2. Application data 917 may include data corresponding to 208-214 described above in conjunction with FIG. 2.

Peripherals 908 may be included within server device 900 or operatively coupled to communicate with server device 900. Peripherals 908 may include, for example, network subsystem 918, input controller 920, and disk controller 922. Network subsystem 918 may include, for example, an Ethernet of WiFi adapter. Input controller 920 may be any known input device technology, including but not limited to a keyboard (including a virtual keyboard), mouse, track ball, and touch-sensitive pad or display. Disk controller 922 may include one or more mass storage devices for storing data files; such devices include magnetic disks, such as internal hard disks and removable disks; magneto-optical disks; and optical disks.

FIG. 10 is an example computing device that may be used within the system 200 of FIG. 2, according to an embodiment of the present disclosure. In some embodiments, device 1000 may be any of user devices 202a-n. The illustrative user device 1000 may include a memory interface 1002, one or more data processors, image processors, central processing units 1004, and/or secure processing units 1005, and peripherals subsystem 1006. Memory interface 1002, one or more processors 1004 and/or secure processors 1005, and/or peripherals subsystem 1006 may be separate components or may be integrated in one or more integrated circuits. The various components in user device 1000 may be coupled by one or more communication buses or signal lines.

Sensors, devices, and subsystems may be coupled to peripherals subsystem 1006 to facilitate multiple functionalities. For example, motion sensor 1010, light sensor 1012, and proximity sensor 1014 may be coupled to peripherals subsystem 1006 to facilitate orientation, lighting, and proximity functions. Other sensors 1016 may also be connected to peripherals subsystem 1006, such as a global navigation satellite system (GNSS) (e.g., GPS receiver), a temperature sensor, a biometric sensor, magnetometer, or other sensing device, to facilitate related functionalities.

Camera subsystem 1020 and optical sensor 1022, e.g., a charged coupled device (CCD) or a complementary metal-oxide semiconductor (CMOS) optical sensor, may be utilized to facilitate camera functions, such as recording photographs and video clips. Camera subsystem 1020 and optical sensor 1022 may be used to collect images of a user to be used during authentication of a user, e.g., by performing facial recognition analysis.

Communication functions may be facilitated through one or more wired and/or wireless communication subsystems 1024, which may include radio frequency receivers and transmitters and/or optical (e.g., infrared) receivers and transmitters. For example, the Bluetooth (e.g., Bluetooth low energy (BTLE)) and/or WiFi communications described herein may be handled by wireless communication subsystems 1024. The specific design and implementation of communication subsystems 1024 may depend on the communication network(s) over which the user device 1000 is intended to operate. For example, user device 1000 may include communication subsystems 1024 designed to operate over a GSM network, a GPRS network, an EDGE network, a WiFi or WiMax network, and a Bluetooth™ network. For example, wireless communication subsystems 1024 may include hosting protocols such that device 1000 may be configured as a base station for other wireless devices and/or to provide a WiFi service.

Audio subsystem 1026 may be coupled to speaker 1028 and microphone 1030 to facilitate voice-enabled functions, such as speaker recognition, voice replication, digital recording, and telephony functions. Audio subsystem 1026 may be configured to facilitate processing voice commands, voice-printing, and voice authentication, for example.

I/O subsystem 1040 may include a touch-surface controller 1042 and/or other input controller(s) 1044. Touch-surface controller 1042 may be coupled to a touch-surface 1046. Touch-surface 1046 and touch-surface controller 1042 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 1046.

The other input controller(s) 1044 may be coupled to other input/control devices 1048, such as one or more buttons, rocker switches, thumb-wheel, infrared port, USB port, and/or a pointer device such as a stylus. The one or more buttons (not shown) may include an up/down button for volume control of speaker 1028 and/or microphone 1030.

In some implementations, a pressing of the button for a first duration may disengage a lock of touch-surface 1046; and a pressing of the button for a second duration that is longer than the first duration may turn power to user device 1000 on or off. Pressing the button for a third duration may activate a voice control, or voice command, module that enables the user to speak commands into microphone 1030 to cause the device to execute the spoken command. The user may customize a functionality of one or more of the buttons. Touch-surface 1046 may, for example, also be used to implement virtual or soft buttons and/or a keyboard.

In some implementations, user device 1000 may present recorded audio and/or video files, such as MP3, AAC, and MPEG files. In some implementations, user device 1000 may include the functionality of an MP3 player, such as an iPod™. User device 1000 may, therefore, include a 36-pin connector and/or 8-pin connector that is compatible with the iPod. Other input/output and control devices may also be used.

Memory interface 1002 may be coupled to memory 1050. Memory 1050 may include high-speed random access memory and/or non-volatile memory, such as one or more magnetic disk storage devices, one or more optical storage devices, and/or flash memory (e.g., NAND, NOR). Memory 1050 may store an operating system 1052, such as Darwin, RTXC, LINUX, UNIX, OS X, Windows, or an embedded operating system such as VxWorks.

Operating system 1052 may include instructions for handling basic system services and for performing hardware dependent tasks. In some implementations, operating system 1052 may be a kernel (e.g., UNIX kernel). In some implementations, operating system 1052 may include instructions for performing voice authentication.

Memory 1050 may also store communication instructions 1054 to facilitate communicating with one or more additional devices, one or more computers and/or one or more servers. Memory 1050 may include graphical user interface instructions 1056 to facilitate graphic user interface processing; sensor processing instructions 1058 to facilitate sensor-related processing and functions; phone instructions 1060 to facilitate phone-related processes and functions; electronic messaging instructions 1062 to facilitate electronic messaging-related process and functions; web browsing instructions 1064 to facilitate web browsing-related processes and functions; media processing instructions 1066 to facilitate media processing-related functions and processes; GNSS/Navigation instructions 1068 to facilitate GNSS and navigation-related processes and instructions; and/or camera instructions 1070 to facilitate camera-related processes and functions.

Memory 1050 may store application (or “app”) instructions and data 1072, such as instructions for the apps described above in the context of FIGS. 2-8. Memory 1050 may also store other software instructions 1074 for various other software applications in place on device 1000.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method performed by a server for understanding documents, said method comprising:
receiving, via a network, a document from a user device associated with a user;
detecting an anomaly in the document;
generating a query based on the anomaly;
inputting the query into a trained question-answer (QA) model;
identifying, via the QA model, contextual information associated with the query; and
providing the contextual information to the user device.

2. The method of claim 1, wherein detecting the anomaly in the document comprises:
detecting an empty space in the document; and
analyzing the empty space to determine that the empty space should not be empty.

3. The method of claim 2, wherein analyzing the empty space comprises:
detecting a document type of the received document;
identifying a field associated with the empty space;
comparing the identified field to one or more fields of a plurality of historical same-type documents; and
determining, based on the comparing of the identified field to the one or more fields of the plurality of historical same-type documents, that the empty space should not be empty.

4. The method of claim 3, wherein determining, based on the comparing of the identified field to the one or more fields of the plurality of historical same-type documents, that the empty space should not be empty comprises:
calculating a number of the plurality of historical same-type documents where the one or more fields are empty; and
determining that the empty space should not be empty when the calculated number is below a pre-defined threshold.

5. The method of claim 3, wherein determining, based on the comparing of the identified field to the one or more fields of the plurality of historical same-type documents, that the empty space should not be empty comprises:
calculating a percentage of the plurality of historical same-type documents where the one or more fields are empty; and
determining that the empty space should not be empty when the percentage is below a pre-defined threshold.

6. The method of claim 3, wherein analyzing the empty space to determine that the empty space should not be empty comprises:
detecting a type of the document;
identifying a field associated with the empty space; and
determining, based on the identified field and document type, that the empty space should not be empty.

7. The method of claim 1, wherein the document relates to a tax or financial service and the trained QA model comprises a bidirectional encoder representation from transformers (BERT) model fine-tuned with at least one of tax-related keywords and finance-related keywords.

8. The method of claim 1, wherein identifying, via the QA model, the contextual information associated with the query comprises:
embedding the query with a query vector;
embedding at least one body of text to at least one body vector; and
identifying a span of text from the at least one body of text relevant to the query.

9. The method of claim 8, wherein providing the contextual information to the user device comprises:
de-embedding the identified span of text from a vector format to text; and
outputting the span of text to the user device.

10. A system for understanding documents comprising:
a server communicably coupled via a network to a user device, the server configured to:
receive, via the network, a document from the user device;
detect an anomaly in the document;
generate a query based on the anomaly;
input the query into a trained question-answer (QA) model;
identify, via the QA model, contextual information associated with the query; and
provide the contextual information to the user device.

11. The system of claim 10, wherein to detect the anomaly in the document, the server is configured to:
detect an empty space in the document; and
analyze the empty space to determine that the empty space should not be empty.

12. The system of claim 11, wherein to analyze the empty space, the server is configured to:
detect a document type of the received document;
identify a field associated with the empty space;
compare the identified field to one or more fields of a plurality of historical same-type documents; and
determine, based on the comparing of the identified field to the one or more fields of the plurality of historical same-type documents, that the empty space should not be empty.

13. The system of claim 12, wherein to determine, based on the comparing of the identified field to the one or more fields of the plurality of historical same-type documents, that the empty space should not be empty, the server is configured to:
calculate a number of the plurality of historical same-type documents where the one or more fields are empty; and
determine that the empty space should not be empty when the calculated number is below a pre-defined threshold.

14. The system of claim 12, wherein to determine, based on the comparing of the identified field to the one or more fields of the plurality of historical same-type documents, that the empty space should not be empty, the server is configured to:
calculate a percentage of the plurality of historical same-type documents where the one or more fields are empty; and
determine that the empty space should not be empty when the percentage is below a pre-defined threshold.

15. The system of claim 12, wherein to analyze the empty space to determine that the empty space should not be empty, the server is configured to:
detect a type of the document;
identify a field associated with the empty space; and
determine, based on the identified field and document type, that the empty space should not be empty.

16. The system of claim 10, wherein the QA model comprises a bidirectional encoder representation from transformers (BERT) model fine-tuned with at least one of tax-related keywords and finance-related keywords.

17. The system of claim 10, wherein to identify, via the QA model, the contextual information associated with the query, the server is configured to:
embed the query with a query vector;
embed at least one body of text to at least one body vector; and
identify a span of text from the at least one body of text relevant to the query.

18. The system of claim 17, wherein to provide the contextual information to the user device, the server is configured to:
de-embed the identified span of text from a vector format to text; and
output the span of text to the user device.

19. A system for understanding documents comprising:
a server communicably coupled via a network to a user device, the server configured to:
receive, via the network, a document from the user device;
identify a plurality of values in a plurality of fields in the electronic document;
detect an anomaly in at least one of the plurality of values;
generate a query based on the anomaly;
input the query into a trained question-answer (QA) model;
identify, via the QA model, contextual information associated with the query; and
provide the contextual information to the user device.

20. The system of claim 19, wherein to identify, via the QA model, the contextual information associated with the query, the server is configured to:
embed the query with a query vector;
embed at least one body of text to at least one body vector; and
identify a span of text from the at least one body of text relevant to the query.
